(19) United States
(12) Patent Application Publication
(10) Pub. No.: US 2016/0253077 A1
(43) Pub. Date: Sep. 1, 2016

(54) SYNCHRONIZING SYSTEM AND METHOD FOR SYNCING EVENT LOGS FROM DIFFERENT MONITORING SYSTEMS

(71) Applicant: General Electric Company, Schenectady, NY (US)

(72) Inventor: Steven Andrew Kellner, Melbourne, FL (US)

(21) Appl. No.: 14/633,633

(22) Filed: Feb. 27, 2015

(51) Int. Cl. G06F 3/0484; G06F 17/30

(52) U.S. Cl. CPC G06F 3/04847; G06F 17/30528; G06F 17/30554

(57) ABSTRACT

A synchronizing system and method receive event log data from different monitoring systems. The event log data represents operational events of a powered system recorded by the monitoring systems and corresponding times of the operational events. The monitoring systems record the event log data at different time bases and/or sampling rates. The event log data from the monitoring systems are temporally correlated with each other by changing the time bases of the event log data to a common time base and/or by changing a visual presentation of the event log data such that the event log data are visually presented with a common time scale responsive to the sampling rates differing from each other.

### FIELD

Embodiments of the subject matter described herein relate to data logs generated by systems that monitor operations of other systems.

### BACKGROUND

Data logs can be generated using measurements of a system in operation. These logs can be useful sources of information for analyzing performance of the operating system. For example, changes in the data, trends in the data, or the like, can be indicative of decreased output of a vehicles, a mechanical fault in a power plant, a need for repair or maintenance of a network, or the like. Typically, data logs are used to perform a “post mortem” analysis of the system after some anomalous behavior has occurred in order to identify a cause of the anomalous behavior. Additionally, the data logs can be used to analyze operation of the system in order to predict when the system is likely to fail, required maintenance, or the like, before the system actually fails or requires maintenance.

In order to more accurately examine the data in these types of logs, a user may analyze logs generated by different data sources used by different systems. For example, the user may examine orthogonal data provided by different types of data sources to identify a mechanical fault in a vehicle in an effort to eliminate or reduce the possibility of incorrect diagnosis of the fault from the data.

But, different data sources may provide and/or record the data in different ways. For example, some data sources may be set to different times or time zones. This can cause the data in the logs provided by the different data sources to appear to have been recorded at different times, even though the data was recorded at the same time.

As another example, different data sources may measure the data at different rates. For example, some data sources may measure the data at a slower frequency or less often than other data sources. The logs provided by these data sources can appear to extend over different time periods when presented to the user, even though the data actually was acquired over the same time period.

The different times and/or measurement rates of the data sources can make it very difficult for a user to compare the logs from the different data sources. The user may need considerably long periods of time to determine how the data in different logs are related to each other, when the different data were collected, or the like. As a result, analysis of the data logs can take considerably longer than is commercially and/or safely reasonable.

### BRIEF DESCRIPTION

In one embodiment, a method (e.g., for syncing data recorded in event logs from different monitoring systems) includes receiving first event log data from a first monitoring system of a powered system. The first event log data represents first operational events of the powered system recorded by the first monitoring system and corresponding first times at which the first operational events are recorded by the first monitoring system as occurring. The method also can include receiving second event log data from a second monitoring system of the powered system. The second event log data represents second operational events of the powered system recorded by the second monitoring system and corresponding second times at which the second operational events are recorded by the second monitoring system as occurring. The first monitoring system records the first event log data at one or more of a first time base that differs from a second time base at which the second monitoring system records the second event log data or a first sampling rate that differs from a second sampling rate at which the second monitoring system records the second event log data. The method also can include temporally correlating the first event log data with the second event log data by one or more of changing one or more of the first time base of the first event log data or the second time base of the second event log data to a common time base and/or changing a visual presentation of one or more of the first event log data or the second event log data on a display device such that the first event log data and the second event log data are visually presented with a common time scale responsive to the first sampling rate of the first event log data differing from the second sampling rate of the second event log data.

In one embodiment, a system (e.g., a synchronizing system) includes first and second monitoring systems of a powered system and a controller. The first monitoring system is configured to generate first event log data representative of first operational events of the powered system and corresponding first times at which the first operational events are recorded by the first monitoring system as occurring. The second monitoring system of the powered system is configured to generate second event log data representative of second operational events of the powered system and corresponding second times at which the second operational events are recorded by the second monitoring system as occurring. The first monitoring system is configured to record the first event log data at one or more of a first time base that differs from a second time base at which the second monitoring system records the second event log data or a first sampling rate that differs from a second sampling rate at which the second monitoring system records the second event log data. The controller is configured to temporally correlate the first event log data with the second event log data by one or more of changing one or more of the first time base of the first event log data or the second time base of the second event log data to a common time base and/or changing a visual presentation of one or more of the first event log data or the second event log data on a display device such that the first event log data and the second event log data are visually presented with a common time scale responsive to the first sampling rate of the first event log data differing from the second sampling rate of the second event log data.

In another embodiment, a system (e.g., a synchronizing system) includes first and second monitoring systems of a powered system and a controller. The first monitoring system is configured to generate first event log data representative of first operational events of the powered system and corresponding first times at which the first operational events are recorded by the first monitoring system as occurring. The second monitoring system is configured to generate second event log data representative of second operational events of the powered system and corresponding second times at which the second operational events are recorded by the second monitoring system as occurring. The first monitoring system can be configured to record the first event log data at one or more of a first time base that differs from a second time base at which the second monitoring system records the second event log data or a first sampling rate that differs from a second sampling rate at which the second monitoring system records the second event log data. The controller can be configured to temporally correlate the first event log data with the second event log data by automatically determining one or more of a time base temporal difference between the first time base and the second time base, and/or a sampling rate temporal difference between the first sampling rate and the second sampling rate by identifying at least a first feature of interest in the first event log data and at least a second feature of interest in the second event log data and determining a difference between when the at least the first feature of interest occurs in the first event log data and when the at least the second feature of interest occurs in the second event log data.

### BRIEF DESCRIPTION OF THE DRAWINGS

Reference is now made briefly to the accompanying drawings, in which:

FIG. 1 is a flowchart of one embodiment of a method for syncing data recorded in event logs from different monitoring systems;

FIG. 2 illustrates a schematic diagram of a powered system according to one embodiment;

FIG. 3 is a schematic view of a synchronizing system according to one embodiment;

FIG. 4 illustrates a set of event log data having a first sampling rate;

FIG. 5 illustrates another set of event log data having a second sampling rate that differs from the first sampling rate;

FIG. 6 illustrates a set of event log data having a first time base; and

FIG. 7 illustrates another set of event log data having a second time base that is different from the first time base.

### DETAILED DESCRIPTION

One or more embodiments of the subject matter described herein provide methods and synchronizing systems that temporally synchronize event logs generated by different monitoring systems monitoring the one or more powered systems. The monitoring systems may monitor the same powered system, or may monitor two or more powered systems acting in coordination or concert with one another. For example, multiple monitoring systems can monitor the same or different operations of a single vehicle. As another example, multiple monitoring systems can monitor operations of two or more vehicles in a vehicle consist, such as systems that monitor distributed power (DP) operations of two or more rail vehicles in a rail vehicle consist. The monitoring systems may record data representative of operational events of the powered system in different event logs. The monitoring systems may have different time bases (e.g., different clocks set at different times) and/or may record the data at different sampling rates. As a result, the event log provided by one monitoring system may not temporally match up with the event logs provided by one or more other monitoring systems. The event logs may not temporally match each other even though the monitoring systems may be monitoring the same powered system or the same component of the powered system. For example, features of interest in the event logs (e.g., peaks, valleys, waveforms, or the like, in the data recorded in the logs) representative of the same operational events (e.g., simultaneous changes in throttle settings, brake settings, speeds, or the like) may appear to occur at different absolute times and/or relative times in different event logs.

The synchronization systems and methods can automatically examine the event data logs (e.g., without user intervention) to temporally correlate the event data logs. For example, the systems and methods can determine differences in time bases of the logs (e.g., which may occur when one monitoring system has a clock set to a different time zone or different time than another monitoring system) based on the same or similar features of interest appearing at different times in the event data logs. Additionally or alternatively, the systems and methods can determine differences in sampling frequencies used by the monitoring systems to generate the logs based on the same or similar features of interest having different proportionalities (e.g., different horizontal and/or vertical sizes in graphical representations of the data in the logs). For example, the same peak in two different event data logs may appear wider (e.g., extend over a greater horizontal distance representative of time or number of samples on a graphical representation of the event data) in a first data log than in a second data log due to the data in the first data log being measured at a greater frequency (e.g., more often) than the data in the second data log. As another example, the same peak in two different event data logs may appear taller (e.g., extend higher along a vertical distance) in a first data log than in a second data log due to the data in the first data log being measured at a different scale or unit. The systems and methods can analyze time periods between features of interest (also referred to as events of interest) in the event data logs and apply proportional logic to synchronize the logs with different time bases and/or periodicity of logging.

Based on differences between the time bases and/or sampling frequencies of the event data logs, the systems and methods can identify temporal differences between the event data logs. These temporal differences can be used to automatically modify the data in one or more of the event data logs and/or to automatically generate a visual representation of the event data logs on a display device so that the event data logs are temporally synced with each other. A user can then more easily compare or contrast events represented by the data in the event data logs than prior to the temporal correlation of the event data logs.

Prior to the systems and methods described herein, human users would rely on manual examination of multiple event data logs to analyze events that occurred on a powered system. Because different data sources or other components record data of the powered system at different time bases and/or different sampling frequencies, the user often needs to go through a time consuming process of manually synchronizing the logs. If the logs include a significant amount of data over an extended period of time, this process and be inexact and very arduous. For example, manual examination of the logs can consume more than a commercially reasonable time period and/or more than a safely reasonable time period. In contrast, automatically examining the event data logs can contribute to a significant improvement to the functioning of the powered system in that problems or faults with the powered system can more quickly be identified and/or confirmed from the temporally different event data logs. While a user may take several hours, days, weeks, or longer, to identify temporal differences between different logs, synchronize the logs, and then examine the data in the synchronized logs to identify data indicative of problems or faults of the powered system, the systems and methods herein allow for the temporally synched logs or data to be examined significantly faster to allow for faster responses and/or remedial actions than otherwise would be achieved. For example, a problem or fault with the powered system can be identified in significantly less time to thereby permit the powered system to be repaired and put back into service, to identify potential hazards with operation of the powered system or other powered systems, or the like, much more quickly than is currently achievable.

While the description herein focuses on temporally correlating event data logs generated by monitoring systems onboard a powered system such as a vehicle, not all embodiments are so limited. The powered system can be any of a variety of systems that operate to perform work, process information, communicate information, or the like. For example, the powered system may refer to a computer or computing system, a power plant, a rail vehicle, a vehicle other than a rail vehicle, a heating and/or air conditioning unit, or the like.

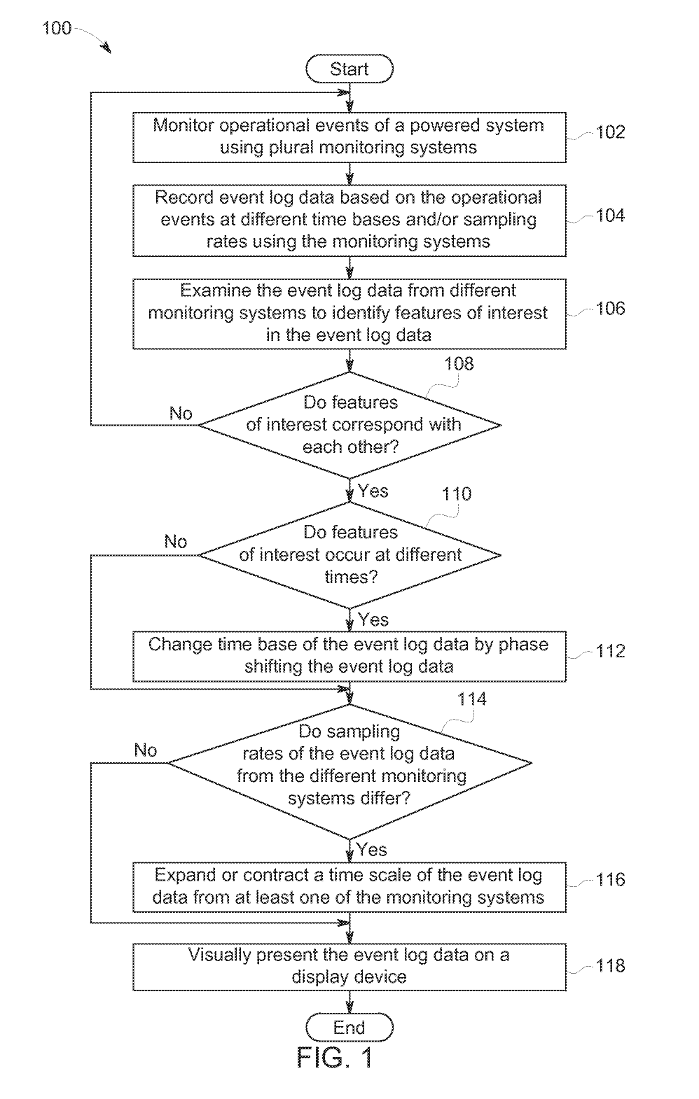

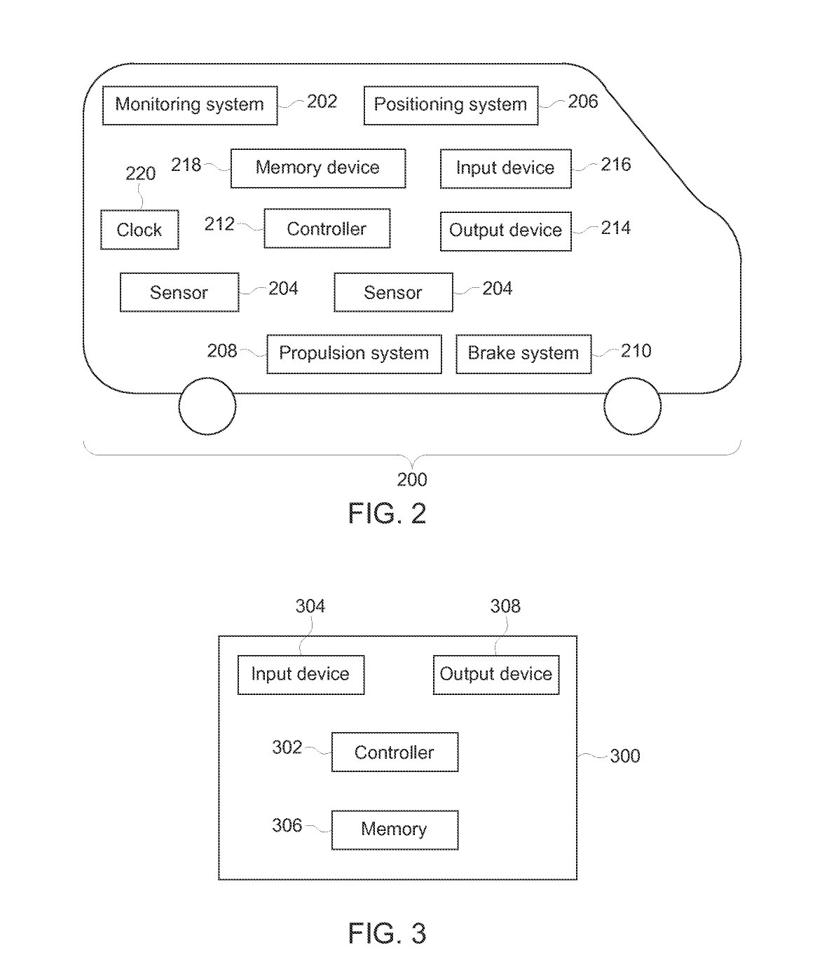

FIG. 1 is a flowchart of one embodiment of a method 100 for syncing data recorded in event logs from different monitoring systems. The method 100 can be used to sync data generated by different monitoring systems that are monitoring operation of the same powered system. In one embodiment, the method 100 can be used to sync event logs that represent operations of a powered system 200 shown in FIG. 2.

FIG. 2 illustrates a schematic diagram of the powered system 200 according to one embodiment. The powered system 200 includes several components shown in FIG. 2. These components can be connected with each other by wired and/or wireless connections to communicate information between or among the components. The powered system 200 represents a vehicle in FIG. 2, but optionally can represent another type of powered system. The illustrated powered system 200 includes a propulsion system 208 that may comprise one or more engines, motors, batteries, or the like, that generate and/or consume energy to propel or otherwise move the powered system 200. The illustrated powered system 200 also includes a brake system 210, such as air brakes, friction brakes, electromagnetic brakes, or the like, that operate to stop or slow movement of the brake system 210. A controller 212 can represent one or more processors that control operations of the powered system 200. An output device 214 can represent one or more devices that provide information to a user or user of the powered system 200, such as a display device, touchscreen, monitor, speaker, or the like. An input device 216 can represent one or more devices that receive information from the user or user, such as a throttle, a brake, a lever, buttons, a keyboard, an electronic mouse, a touchscreen, a microphone, or the like.

Returning to the description of the method 100 shown in FIG. 1, at 102, operational events of the powered system are monitored using two or more of the monitoring systems. The powered system 200 shown in FIG. 2 can perform operations, such as traveling along a route, track, waterway, airway, or the like, and monitoring systems 202, 204, 206 can generate data representative of operations of the powered system 200. The monitoring systems 204 can be referred to as data sources, sensors, or the like, and the monitoring system 206 is referred to as a positioning system in FIG. 2. The monitoring systems 202, 204, 206 can include data sources or other devices that measure, calculate, observe, or otherwise monitor operations of the powered system 200 and/or components of the powered system 200 to generate event data representative of the operations of the powered system 200.

As one example, one or more of the monitoring systems 202, 204, 206 can include a speed sensor that determines how fast the powered system 200 is moving and/or how fast an engine of a propulsion system 208 of the powered system 200 is rotating. Such a speed sensor can include a tachometer, a wireless position sensor (e.g., a global positioning system receiver), a wheel speed sensor, a speedometer, a pitometer log, a pitot tube, an airspeed gauge, a piezoelectric sensor, an optical sensor (e.g., a light detection and ranging sensor, or LiDAR sensor), or the like. As another example, one or more of the monitoring systems 202, 204 can include a brake sensor that measures an effectiveness or state of the brake system 210, such as an airbrake pressure sensor, a thermocouple (to measure temperatures of the brake system 210), or the like. As another example, one or more of the monitoring systems 202, 204 can determine locations or positions of the input device 216, such as throttle positions, accelerator positions, pedal positions, brake positions, cruise control settings, or the like. As another example, one or more of the monitoring systems 206 can include a positioning system 206 that determines locations and/or speeds of the powered system 200. The positioning system 206 shown in FIG. 2 can represent a global positioning system (GPS) receiver, a wireless transducer for triangulating locations and/or speeds of the powered system 200, or the like. Other examples of monitoring systems 202, 204, 206 can include voltmeters, cameras, accelerometers, thermometers, or the like.

The monitoring systems 202, 204, 206 can generate data (e.g., event data or operational data) representative of operations of the powered system 200. For example, the monitoring systems 202, 204, 206 can generate data representative of speeds, brake settings, air pressures, vibrations, temperatures, or the like, of the powered system 200. The data can be communicated to the controller 212 and/or stored in an onboard memory device 218. The memory device 218 represents one or more onboard devices that electronically and/or magnetically store data. For example, the memory device 218 may represent a computer hard drive, random access memory, read-only memory, dynamic random access memory, an optical drive, or the like.

The monitoring systems can measure data representative of the same operation of the same powered system at the same time. For example, while one monitoring system 202 is measuring speeds of the powered system 200 using a first type of data source (e.g., wheel speed sensor), another monitoring system 206 may be measuring the same operations (e.g., speed) using a different, second type of data source (e.g., GPS receiver). As another example, one monitoring system 204 may measure different operations of the same powered system. For example, one monitoring system 204 can measure air pressures in an air brake of the brake system 210 while another monitoring system 204 measures positions of a brake lever (e.g., the input device 216). Optionally, other monitoring systems can monitor other operations of the powered system 200.

At 104, event log data is recorded based on operational events using the monitoring systems. The event log data includes the values of the measurements made by the monitoring systems and recorded in the event logs. The monitoring systems can save the data that is monitored by the monitoring systems in a log or other memory structure. Such a memory structure can be saved in an internal memory of the controller 212, in the memory device 218, or in another location. The log can include values of the data measured by the monitoring system, along with a time at which the data is measured or the operation (which the data represents) of the powered system occurred. For example, if there is a delay between a change in speeds and when a monitoring system measures the change in speeds, then the time that is saved in the log with the speed data from the monitoring system may indicate when the speed changed instead of when the data was recorded or saved in the log.

The monitoring systems may record the event log data using different time bases. For example, a clock 220 of the powered system 200 may provide a time to one, but not all, of the monitoring systems 202, 204, 206 to use in recording in the event log data. Optionally, the monitoring systems 202, 204, 206 may include internal clocks and/or may determine time in another manner (e.g., based on received wireless signals, such as from a GPS satellite). These clocks 220 used by the monitoring systems 202, 204, 206 may provide different times to the monitoring systems 202, 204, 206. For example, the clocks 220 may be manually or automatically set to different time zones, may be set to different times (e.g., the minutes and/or seconds are different, but the hours are the same or the difference in time between clocks is not an integer multiple of an hour), or the like. As a result, the data that is recorded by different monitoring systems 202, 204, 206 at the same time may appear in the event logs to be data from different times, time zones, or the like. The times at which the clocks are set can define the time bases of the clocks. Different time bases used by different monitoring systems 202, 204, 206 can cause data representative of the same event to appear as though the data was acquired at different times due to the different time bases. For example, monitoring systems that are set to different times or different time zones may be temporally shifted, or phase shifted, by a difference equal to the difference between the clocks of the monitoring systems.

The monitoring systems may record the event log data at different sampling rates. The sampling rate of a monitoring system can represent how often or frequently the monitoring system measures data for the event log data. For example, one monitoring system 204 may measure data at a sampling rate of once per second, while another monitoring system 204 measures data at a different sampling rate, such as once per ten seconds or another rate. As a result, the event data log created by one monitoring system may include more data than the event data log created by another, different monitoring system. In one embodiment, the event data log may not indicate the sampling rate at which the data included in the log was acquired or recorded. For example, the event data log may include the times at which the data was acquired or recorded, but may not explicitly state the frequency at which the data is acquired or recorded.

The event log data from different monitoring systems can be examined in order to analyze operations of the powered system, to diagnose faults with the powered system, or the like. In one aspect, event log data having different time bases and/or sampling rates can be examined by a synchronizing system in order to temporally synchronize the event log data. This event log data can come from different monitoring systems or can come from the same monitoring system. A single monitoring system may record different data representative of operations of the powered system using different time bases and/or sampling rates. As one example, a single monitoring system may record air brake pressures less often than the monitoring system records speeds of a vehicle.

FIG. 3 is a schematic view of a synchronizing system 300 according to one embodiment. The synchronizing system 300 may be disposed onboard or off-board the powered system 200 shown in FIG. 2. Optionally, one portion of the synchronizing system 300 may be disposed onboard the powered system 200 while one or more other portions of the synchronizing system 300 are disposed off-board the powered system 200. The synchronizing system 300 includes a controller 302, which includes hardware circuits or circuitry having and/or connected with one or more processors. The controller 302 communicates with an input device 304, such as a wired and/or wireless data connection with the monitoring systems and/or controller of the powered system 200, a keyboard, a touchscreen, an electronic mouse, or the like, to receive the event log data from the monitoring systems of the powered system. The event log data may be stored in a memory device 306 (“memory” in FIG. 3) that electronically and/or magnetically stores data. For example, the memory device 306 may represent a computer hard drive, random access memory, read-only memory, dynamic random access memory, an optical drive, or the like. The controller 302 examines the event log data to identify one or more temporal differences between the event log data (e.g., different time bases and/or different sampling rates) as described herein. The controller 302 may alter the event log data based on the identified temporal differences and/or change how the event log data is presented to a user based on the identified temporal differences, also as described herein. For example, the synchronized event log data may be presented on an output device 308, such as an electronic display device, a touchscreen, a printer, or the like.

Returning to the description of the flowchart of the method 100 shown in FIG. 1, at 106, the event log data is examined to identify features of interest. In embodiment, the event log data that is examined is obtained from different monitoring systems. Alternatively, the event log data may be obtained from the same monitoring system. A feature of interest in the event log data may include a waveform, such as a peak, valley, plateau, or the like, that would appear in a graphical representation of the event log data. Alternatively, the feature of interest may include a deviation or change in a baseline or designated value of the event log data. For example, a baseline or designated value of the event log data can be calculated as an average value, median value, or the like, of the event log data. When the event log data increases or decreases from this value, a feature of interest may be identified. The controller of the synchronizing system may examine the event log data to identify the features of interest.

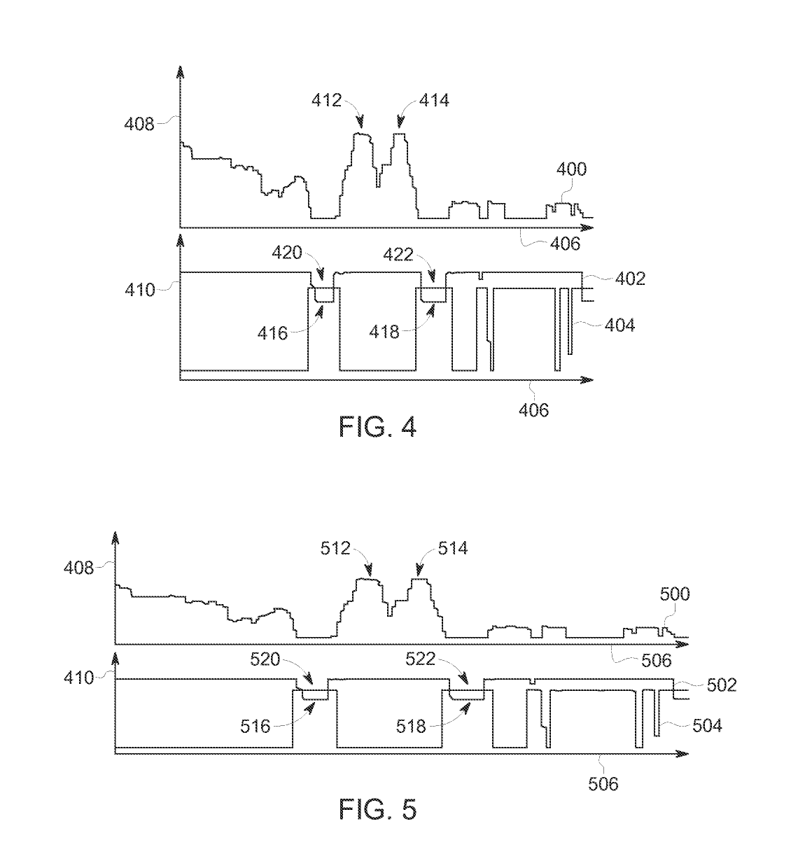

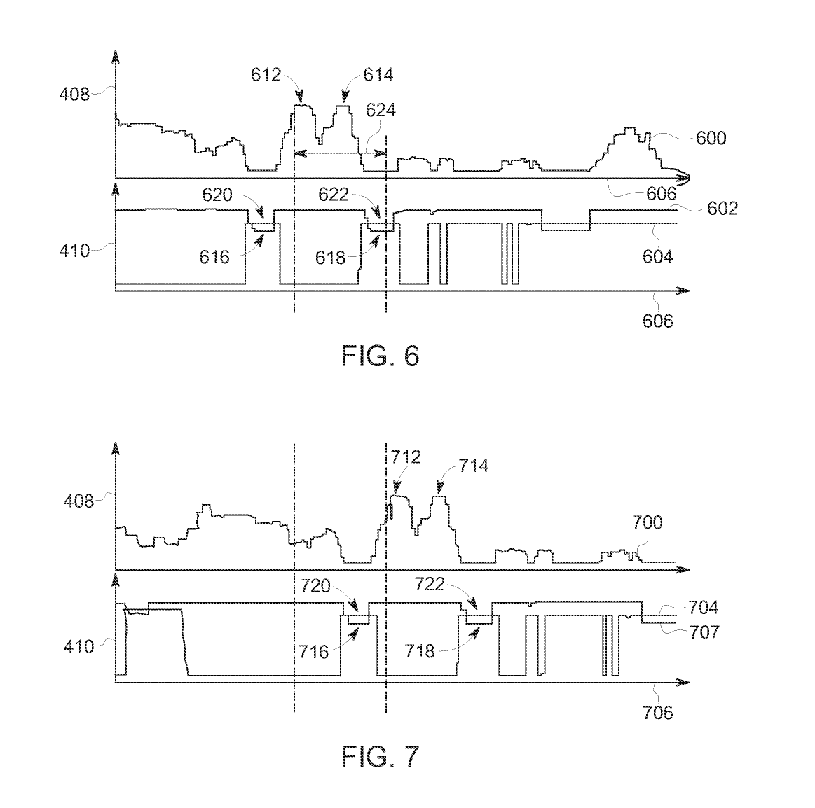

FIGS. 4 through 7 illustrate different sets of event log data from monitoring systems onboard the powered system according to one example. FIGS. 4 and 5 illustrate three sets of event log data having different sampling rates. FIGS. 6 and 7 illustrate three sets of event log data having different time bases.

With respect to FIGS. 4 and 5, the sets of event log data shown in FIG. 4 include event log data 400 representative of speeds of the powered system 200 shown in FIG. 2, event log data 402 representative of air pressures in an air brake of the brake system 210 of the powered system 200, and event log data 404 representative of air pressures in a brake cylinder of the brake system 210. The event log data 400, 402, 404 shown in FIG. 4 are displayed alongside horizontal axes 406 representative of time and/or a number of samples or measurements of the event log data, and alongside vertical axes 408, 410 representative of magnitudes of the event log data.

The sets of event log data shown in FIG. 5 include event log data 500 representative of speeds of the powered system 200 but obtained at a different sampling rate than the event log data 500, event log data 502 representative of air pressures in an air brake of the brake system 210 of the powered system 200 but obtained at a different sampling rate than the event log data 402, and event log data 504 representative of air pressures in a brake cylinder of the brake system 210 but obtained at a different sampling rate than the event log data 404. The event log data 500, 502, 504 shown in FIG. 5 are displayed alongside horizontal axes 506 representative of time and/or a number of samples or measurements of the event log data, and alongside the vertical axes 408, 410 described above.

The sampling rates at which the event log data shown in FIGS. 4 and 5 were recorded may differ in that the event log data 500, 502, 504 were obtained or recorded at a faster sampling rate or frequency. As a result, the graphical representation of the event log data 500, 502, 504 shown in FIG. 5 may extend over a longer distance along the horizontal axis 506 than the event log data 400, 402, 404 along the horizontal axis 406 shown in FIG. 4. The event log data obtained at the faster sampling rate may appear expanded or distended relative to the event log data obtained at the slower sampling rate.

With respect to FIGS. 6 and 7, the sets of event log data shown in FIG. 6 include event log data 600 representative of speeds of the powered system, event log data 602 representative of air pressures in an air brake of the brake system of the powered system, and event log data 604 representative of air pressures in a brake cylinder of the brake system. The event log data 600, 602, 604 are displayed alongside horizontal axes 606 representative of time and the vertical axes 408, 410 described above.

The sets of event log data shown in FIG. 7 include event log data 700 representative of speeds of the powered system but obtained at a different time base than the event log data 600, event log data 702 representative of air pressures in an air brake of the brake system of the powered system but obtained at a different time base than the event log data 602, and event log data 704 representative of air pressures in a brake cylinder of the brake system but obtained at a different time base than the event log data 604. The event log data 700, 702, 704 shown in FIG. 7 are displayed alongside horizontal axes 706 representative of time and the vertical axes 408, 410 described above.

The time bases of the event log data shown in FIGS. 6 and 7 may differ in that the event log data 600, 602, 604 appears to have been obtained or recorded at an earlier time. As a result, the graphical representation of the event log data 600, 602, 604 shown in FIG. 6 may appear to be shifted to the left of the event log data 700, 702, 704 shown in FIG. 7.

While the event log data shown in FIGS. 4 through 7 represent speeds and air pressures of the powered system, alternatively, the event log data may represent other operations or measurements of the powered system.

The controller 302 of the synchronizing system 300 can examine the event log data to identify features of interest in the event log data. With respect to the example shown in FIGS. 4 and 5, the controller 302 may identify peaks 412, 414 in the event log data 400 shown in FIG. 4 and peaks 512, 514 in the event log data 500 shown in FIG. 5. Optionally, the controller 302 can identify valleys 416, 418 in the event log data 402 shown in FIG. 4, peaks 420, 422 in the event log data 404 shown in FIG. 4, valleys 516, 518 in the event log data 502 shown in FIG. 5, and/or peaks 520, 522 in the event log data 504 shown in FIG. 5.

With respect to the example shown in FIGS. 6 and 7, the controller 302 may identify peaks 612, 614 in the event log data 600 shown in FIG. 6, valleys 616, 618 in the event log data 602 shown in FIG. 6, peaks 620, 622 in the event log data 604 shown in FIG. 6, peaks 712, 714 in the event log data 700 shown in FIG. 7, valleys 716, 718 in the event log data 702 shown in FIG. 7, and/or peaks 720, 722 in the event log data 704 shown in FIG. 7. Optionally, other features of interest may be identified.

Returning to the description of the flowchart of the method 100 shown in FIG. 1, at 108, a determination is made as to whether one or more features of interest identified in one event log corresponds with one or more features of interest identified in another event log. The controller 302 of the synchronizing system 300 can compare the features of interest in different event logs to determine if the features of interest likely occurred at the same time or during overlapping time periods, even if the time bases and/or sampling rates of the event logs are different. The features of interest may be likely to have occurred at the same time or during overlapping time periods when the controller 302 determines that it is more likely than not that the values of the event log data forming the features of interest were recorded at the same time event though the time bases and/or sampling rates of the event logs may differ.

With respect to the example shown in FIGS. 4 and 5, the controller 302 can examine the event log data 400 and the event log data 500 and determine that the peaks 412, 414 in the event log data 400 correspond with the peaks 512, 514 in the event log data 500. The controller 302 may correlate the peaks 412, 414 with the peaks 512, 514 by examining values of the event log data the precede and/or follow the peaks 412, 414, 512, 514 to determine that the pattern of the peaks 412, 414 with the preceding and/or following data matches the pattern of the peaks 512, 514 with the preceding and/or following data. A pattern can include the number, spacing, size, frequency, or the like, of the features of interest. For example, the pattern of the features of interest in the event log data 400, 500 can be two peaks 412, 414 or 512, 514 with relatively flat segments of data before and after the peaks 412, 414 or 512, 514. Alternatively, another pattern may be identified. For example, the controller 302 can identify patterns in the valleys 416, 418 and the valleys 516, 518, in the peaks 420, 422 and the peaks 520, 522, or the like, based on the relative spacing, frequency of occurrence, or the like, of these features of interest in the respective event logs. The controller 302 also may identify patterns in the features of interest in the event log data 600, 602, 604, 700, 702, 704 shown in FIGS. 6 and 7 in a similar manner.

If the patterns of the features of interest in two or more different event logs correspond with each other, then the controller 302 can determine that the features of interest in the different event logs represent the same event of the powered system 200. For example, a pattern of peaks, valleys, or the like, occurring in two or more different event logs at different times or across different horizontal distances may represent the same operational event of the powered system 200, such as an acceleration event, a braking or other deceleration event, a fault in the powered system 200, or the like. The same operational event may be the exact same event that is monitored by two or more different monitoring systems. For example, the same application of a brake may be monitored by two or more different monitoring systems in different event logs. As a result, flow of the method 100 can proceed to 110. Alternatively, if the patterns do not correspond with each other, then the features of interest may not represent the same event with the powered system. As a result, flow of the method 100 can return to 102.

At 110, a determination is made as to whether the features of interest occur at different times in the different event logs. The controller 302 of the synchronizing system 300 can examine the times recorded in the logs along with the event log data to determine when the data that forms the features of interest in the different logs was measured or recorded. If the data forming the features of interest in the logs was measured or recorded at the same or approximately same time (e.g., within a designated threshold period of time, such as 1%, 3%, 5%, or the like, of the total time in the log), then the controller 302 can determine that the features of interest in the different logs occurred or were measured at the same time in the different logs. As a result, the time bases of the different logs may be the same. For example, the clock used by one monitoring system may be set to the same time and time zone as the clock used by another monitoring system. Flow of the method 100 can then flow to 114.

On the other hand, if the features of interest that correspond with each other in the different logs occur or were recorded at different times, then the monitoring systems may be using different times to measure or record the data in the event logs. As a result, the event log data may have different time bases, even though the data recorded in the different logs may actually have occurred at the same time.

An example of event log data having different time bases is shown in FIGS. 6 and 7. In these Figures, the peaks 612, 614 and the peaks 712, 714 represent the same changes in speed by the powered system 200 as measured by different monitoring systems. For example, the peaks 612, 614 may have been measured by the monitoring system 204 while the peaks 712, 714 were measured by the monitoring system 206. Because the clocks of the monitoring systems 204, 206 are not set to the same time, the peaks 612, 614 appear to occur at an earlier time than the peaks 712, 714. The controller 302 can determine, based at least in part on the features of interest apparently occurring at different times, that the time bases of the monitoring systems and the event logs are different. As a result, flow of the method 100 can proceed to 112.

At 112, the time base of the event log data in at least one of the event logs is changed. The time base of data in an event log can be changed by phase shifting the data by an amount that is equal to or approximately equal to (e.g., within a designated amount, such as 1%, 3%, 5%, or the like) a temporal difference between the features of interest in the different event logs. For example, the time base can be shifted by an amount of hours, minutes, or the like, that are equal to or approximately equal to the time difference between the features of interest.

With respect to the peaks 612, 614 in the event log data 600 and the peaks 712, 714 in the event log data 700 shown in FIGS. 6 and 7, the controller 302 may measure a temporal difference 624 between the pattern formed by the peaks 612, 614 and the pattern formed by the peaks 712, 714. This temporal difference 624 can represent or be equal to the time delay between when the pattern formed by the peaks 612, 614 occurs in the event log data 600 according to the times stored with the event log data 600 and when the pattern formed by the peaks 712, 714 occurs in the event log data 700 according to the times stored with the event log data 700. If the clocks used by the monitoring systems are set to different times zones, then the temporal difference 624 may be equal to an integer multiple of sixty minutes or one hour. If the clocks used by the monitoring systems are set to different times, then the temporal difference 624 may be an amount of hours, minutes, seconds, or the like.

The controller 302 may synchronize the event log data 600 and the event log data 700 by phase shifting the data 600 and/or the data 700. The data 600, 700 can be phase shifted using the temporal difference 624 determined by the controller 302. For example, the controller 302 may change the times stored with the event log data 600 by adding the temporal difference 624 to these times. Alternatively, the controller 302 may change the times stored with the event log data 700 by subtracting the temporal difference 624 from these times.

In one embodiment, the controller 302 can compare patterns in event log data acquired by different monitoring systems to determine the temporal difference, and then phase shift other event log data acquired by one of the monitoring systems. For example, the controller 302 may use the event log data 600, 700 to determine the temporal difference 624, but then may shift the times associated with the event log data 602, 604, 702, and/or 704 by this temporal difference 624.

Once the event log data is phase shifted by the temporal difference 624, the patterns appearing in the event log data from different monitoring systems appear to occur at the same time. For example, the peaks 612, 614 in the event log data 600 may appear to have occurred at the same time at the peaks 712, 714 in the event log data 700.

Returning to the description of the flowchart of the method 100 shown in FIG. 1, at 114, a determination is made as to whether the sampling rates of the event log data generated by the monitoring systems differ from each other. For example, the controller 302 can determine if the event log data from one monitoring system was obtained or measured at a greater frequency or faster rate than the event log data of another monitoring system.

In one aspect, the event logs from the monitoring systems may record the sampling rates used to generate the event log data. The sampling rate may be included in the event logs and/or may be communicated from the monitoring systems to the controller 302. In another aspect, the controller 302 can examine the data in the event logs to determine the sampling rates of the different logs. The controller 302 can examine the times associated with the data in a log to determine how often the data is recorded in the log by the monitoring system. For example, ten measurements are entered into the log by a monitoring system as the event log data every minute, then the controller 302 may determine that the sampling rate for that event log is ten measurements per minute or another value. The controller 302 can determine the sampling rates for different logs and determine whether the sampling rates differ.

If the sampling rates differ, then the different sampling rates can represent another temporal difference between the event logs. This temporal difference can be used to modify presentation of at least one of the logs. With respect to the example shown in FIGS. 4 and 5, the sampling rates of the event log data 400, 402, 404 differ from the sampling rates of the event log data 500, 502, 504. As a result, even though the event log data 400, 402, 404 was measured over the same time period as the event log data 500, 502, 504, the event log data 400, 402, 404 extends over a shorter distance along the horizontal axis 406 than the event log data 500, 502, 504 extends along the horizontal axis 506. This can cause a user or user to mistakenly believe that the events represented by the event log data 400, 402, and/or 404 occurred at different times and/or occurred over shorter time periods than the events represented by the event log data 500, 502, and/or 504. In the flowchart shown in FIG. 1, if the sampling rates differ, then flow of the method 100 can continue to 116. If the sampling rates do not differ, then flow of the method 100 can proceed to 118.

At 116, a time scale of event log data in at least one of the event logs is changed to synchronize the event logs. The time scale of event log data may be expanded or contracted based on a difference between the sampling rates of the event logs being synchronized with each other. The time scale represents how many different measurements of the event data is included per unit of distance along a horizontal axis in a representation of the event log data. For example, the time scale of the event log data 400, 402, 404 shown in FIG. 4 is smaller or shorter than the time scale of the event log data 500, 502, 504 because the representation of the event log data 400, 402, 404 extends over a shorter distance along the horizontal axis 406 than the event log data 500, 502, 504 extends over the horizontal axis 506.

The controller 302 may modify a representation of the event log data in at least one of the event logs so that the time scales of two or more event logs are the same or closer to each other than prior to modifying the representation. For example, the controller 302 may generate display signals that dictate how different event logs are to be displayed on the output device 308 shown in FIG. 3. With respect to the example shown in FIGS. 4 and 5, the controller 302 can generate the signals so that the event log data 400, 402, and/or 404 is horizontally stretched or expanded along the horizontal axis 406 so that the event log data 400, 402, and/or 404 appears to extend over the same time period as the event log data 500, 502, and/or 504. This can result in the event log data 400, 402, and/or 404 appearing more like the event log data 500, 502, and/or 504 in the illustrate example. Optionally, the controller 302 can horizontally shrink or contract the event log data 500, 502, and/or 504 along the horizontal axis 506 so that the event log data 500, 502, and/or 504 appears to extend over the same time period as the event log data 400, 402, and/or 404. This can result in the event log data 500, 502, and/or 504 appearing more like the event log data 400, 402, and/or 404 in the illustrate example.

At 118, the event log data obtained from different monitoring systems is visually presented on a display device. For example, the controller 302 can generate display signals directing the output device 308 to electronically display the event log data. Because the data in the event logs from different monitoring systems have been temporally synched with each other by changing time bases and/or stretching or contracting representations of the data, an human user or user can more easily compare the events represented by the data logs. This user or user can more easily determine what events occurred at the same times or approximately same times by comparing the temporally synched logs with each other.

Additionally or alternatively, the event log data from two or more monitoring systems that is correlated with each other can be used to initiate one or more actions. For example, in addition to or instead of displaying the event log data, the controller may generate one or more signals responsive to correlating the event log data from the monitoring systems. The controller can notify a repair facility, dispatch facility, operator of a vehicle, or the like, of one or more features of interest in the correlated event log data. For example, if a feature of interest is identified in event log data from two different monitoring systems that is temporally correlated with each other, the controller can inform the repair facility so that the repair facility can automatically schedule inspection or repair of a powered system that was monitored by the monitoring systems, so that the dispatch facility can change a scheduled operation or movement of the powered system, or the like.

In one embodiment, a method (e.g., for syncing data recorded in event logs from different monitoring systems) includes receiving first event log data from a first monitoring system of a powered system. The first event log data represents first operational events of the powered system recorded by the first monitoring system and corresponding first times at which the first operational events are recorded by the first monitoring system as occurring. The method also can include receiving second event log data from a second monitoring system of the powered system. The second event log data represents second operational events of the powered system recorded by the second monitoring system and corresponding second times at which the second operational events are recorded by the second monitoring system as occurring. The first monitoring system records the first event log data at one or more of a first time base that differs from a second time base at which the second monitoring system records the second event log data or a first sampling rate that differs from a second sampling rate at which the second monitoring system records the second event log data. The method also can include temporally correlating the first event log data with the second event log data by one or more of changing one or more of the first time base of the first event log data or the second time base of the second event log data to a common time base and/or changing a visual presentation of one or more of the first event log data or the second event log data on a display device such that the first event log data and the second event log data are visually presented with a common time scale responsive to the first sampling rate of the first event log data differing from the second sampling rate of the second event log data.

In one aspect, temporally correlating the first event log data with the second event log data can include changing the one or more of the first time base of the first event log data or the second time base of the second event log data to the common time base by phase shifting one or more of the first event log data or the second event log data.

In one aspect, the first event log data can be temporally correlated with the second event log data by one or more of expanding or contracting a time scale of one or more of the first event log data or the second event log data in the visual presentation.

In one aspect, the method also can include automatically determining one or more of a time base temporal difference between the first time base of the first event log data and the second time base of the second event log data and/or a sampling rate temporal difference between the first sampling rate of the first event log data and the second sampling rage of the second event log data. The first event log data and the second event log data can be temporally correlated based on the one or more of the time base temporal difference or the sampling rate temporal difference.

In one aspect, the one or more of the time base temporal difference and/or the sampling rate temporal difference can be automatically determined by identifying at least a first feature of interest in the first event log data and at least a second feature of interest in the second event log data and determining a difference between when the at least the first feature of interest occurs in the first event log data and when the at least the second feature of interest occurs in the second event log data.

In one aspect, the first monitoring system can include a first clock providing the first time base for the first event log data and the second monitoring system can include a second clock providing the second time base for the second event log data with the first clock and the second clock set to different times. The method can also include syncing the times of the first clock and the second clock based on the time base temporal difference.

In one aspect, the method also can include determining that the first time base of the first monitoring system differs from the second time base of the second monitoring system due to one or more of clocks of the first and second monitoring systems being set to different time zones or the clocks of the first and second monitoring systems being set to different times but not the different time zones.

In one aspect, the first operational events represented by the first event log data can differ from the second operational events represented by the second event log data.

In one aspect, the first operational events represented by the first event log data and the second operational events represented by the second event log data can be the same operational events.

In one aspect, the method also can include visually presenting the first event log data and the second event log data in the common time base on the display device.

In one embodiment, a system (e.g., a synchronizing system) includes first and second monitoring systems of a powered system and a controller. The first monitoring system is configured to generate first event log data representative of first operational events of the powered system and corresponding first times at which the first operational events are recorded by the first monitoring system as occurring. The second monitoring system of the powered system is configured to generate second event log data representative of second operational events of the powered system and corresponding second times at which the second operational events are recorded by the second monitoring system as occurring. The first monitoring system is configured to record the first event log data at one or more of a first time base that differs from a second time base at which the second monitoring system records the second event log data or a first sampling rate that differs from a second sampling rate at which the second monitoring system records the second event log data. The controller is configured to temporally correlate the first event log data with the second event log data by one or more of changing one or more of the first time base of the first event log data or the second time base of the second event log data to a common time base and/or changing a visual presentation of one or more of the first event log data or the second event log data on a display device such that the first event log data and the second event log data are visually presented with a common time scale responsive to the first sampling rate of the first event log data differing from the second sampling rate of the second event log data.

In one aspect, the controller can be configured to temporally correlate the first event log data with the second event log data by one or more of changing the one or more of the first time base of the first event log data or the second time base of the second event log data to the common time base by phase shifting one or more of the first event log data or the second event log data and/or one or more of expanding and/or contracting a time scale of one or more of the first event log data or the second event log data in the visual presentation.

In one aspect, the controller also can be configured to automatically determine one or more of a time base temporal difference between the first time base of the first event log data and the second time base of the second event log data, and/or a sampling rate temporal difference between the first sampling rate of the first event log data and the second sampling rage of the second event log data. The controller can be configured to temporally correlate the first event log data and the second event log data based on the one or more of the time base temporal difference or the sampling rate temporal difference.

In one aspect, the controller can be configured to automatically determine the one or more of the time base temporal difference or the sampling rate temporal difference by identifying at least a first feature of interest in the first event log data and at least a second feature of interest in the second event log data and determining a difference between when the at least the first feature of interest occurs in the first event log data and when the at least the second feature of interest occurs in the second event log data.

In one aspect, the first monitoring system can include a first clock configured to provide the first time base for the first event log data and the second monitoring system can include a second clock configured to provide the second time base for the second event log data with the first clock and the second clock set to different times. The controller can be configured to communicate the time base temporal difference to one or more of the first monitoring system or the second monitoring system. One or more of the first monitoring system and/or the second monitoring system can be configured to sync the first and second clocks based on the time base temporal difference.

In another embodiment, a system (e.g., a synchronizing system) includes first and second monitoring systems of a powered system and a controller. The first monitoring system is configured to generate first event log data representative of first operational events of the powered system and corresponding first times at which the first operational events are recorded by the first monitoring system as occurring. The second monitoring system is configured to generate second event log data representative of second operational events of the powered system and corresponding second times at which the second operational events are recorded by the second monitoring system as occurring. The first monitoring system can be configured to record the first event log data at one or more of a first time base that differs from a second time base at which the second monitoring system records the second event log data or a first sampling rate that differs from a second sampling rate at which the second monitoring system records the second event log data. The controller can be configured to temporally correlate the first event log data with the second event log data by automatically determining one or more of a time base temporal difference between the first time base and the second time base, and/or a sampling rate temporal difference between the first sampling rate and the second sampling rate by identifying at least a first feature of interest in the first event log data and at least a second feature of interest in the second event log data and determining a difference between when the at least the first feature of interest occurs in the first event log data and when the at least the second feature of interest occurs in the second event log data.

In one aspect, the controller can be configured to temporally correlate the first event log data with the second event log data by one or more of changing one or more of the first time base of the first event log data or the second time base of the second event log data to a common time base and/or changing a visual presentation of one or more of the first event log data and/or the second event log data on a display device such that the first event log data and the second event log data are visually presented with a common time scale responsive to the first sampling rate of the first event log data differing from the second sampling rate of the second event log data.

In one aspect, the controller can be configured to temporally correlate the first event log data with the second event log data by one or more of changing the one or more of the first time base of the first event log data or the second time base of the second event log data to the common time base by phase shifting one or more of the first event log data or the second event log data and/or one or more of expanding or contracting a time scale of one or more of the first event log data or the second event log data in the visual presentation.

In one aspect, the first monitoring system can include a first clock configured to provide the first time base for the first event log data and the second monitoring system can include a second clock configured to provide the second time base for the second event log data with the first clock and the second clock set to different times. The controller can be configured to communicate the time base temporal difference to one or more of the first monitoring system or the second monitoring system. One or more of the first monitoring system or the second monitoring system can be configured to sync the first and second clocks based on the time base temporal difference.

In one aspect, the first monitoring system and the second monitoring system can be configured to monitor one or more of throttle settings of the powered system, brake settings of the powered system, and/or speeds of the powered system as the first event log data and the second event log data.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended clauses, along with the full scope of equivalents to which such clauses are entitled. In the appended clauses, the terms “including” and “in which” are used as the plain-English equivalents of the respective terms “comprising” and “wherein.” Moreover, in the following clauses, the terms “first,” “second,” and “third,” etc. are used merely as labels, and are not intended to impose numerical requirements on their objects. Further, the limitations of the following clauses are not written in means-plus-function format and are not intended to be interpreted based on 35 U.S.C. §112(f), unless and until such clause limitations expressly use the phrase “means for” followed by a statement of function void of further structure.

This written description uses examples to disclose several embodiments of the inventive subject matter and also to enable one of ordinary skill in the art to practice the embodiments of inventive subject matter, including making and using any devices or systems and performing any incorporated methods. The patentable scope of the inventive subject matter is defined by the clauses, and may include other examples that occur to one of ordinary skill in the art. Such other examples are intended to be within the scope of the clauses if they have structural elements that do not differ from the literal language of the clauses, or if they include equivalent structural elements with insubstantial differences from the literal languages of the clauses.

The foregoing description of certain embodiments of the present inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be standalone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present inventive subject matter are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

What is claimed is:

1. A method comprising:
receiving first event log data from a first monitoring system of a powered system, the first event log data representing first operational events of the powered system recorded by the first monitoring system and corresponding first times at which the first operational events are recorded by the first monitoring system as occurring;
receiving second event log data from a second monitoring system of the powered system, the second event log data representing second operational events of the powered system recorded by the second monitoring system and corresponding second times at which the second operational events are recorded by the second monitoring system as occurring,
wherein the first monitoring system records the first event log data at one or more of a first time base that differs from a second time base at which the second monitoring system records the second event log data or a first sampling rate that differs from a second sampling rate at which the second monitoring system records the second event log data; and
temporally correlating the first event log data with the second event log data by one or more of:
changing one or more of the first time base of the first event log data or the second time base of the second event log data to a common time base; or
changing a visual presentation of one or more of the first event log data or the second event log data on a display device such that the first event log data and the second event log data are visually presented with a common time scale responsive to the first sampling rate of the first event log data differing from the second sampling rate of the second event log data.

2. The method of claim 1, wherein temporally correlating the first event log data with the second event log data includes changing the one or more of the first time base of the first event log data or the second time base of the second event log data to the common time base by phase shifting one or more of the first event log data or the second event log data.

3. The method of claim 1, the first event log data is temporally correlated with the second event log data by one or more of expanding or contracting a time scale of one or more of the first event log data or the second event log data in the visual presentation.

4. The method of claim 1, further comprising automatically determining one or more of a time base temporal difference between the first time base of the first event log data and the second time base of the second event log data, or a sampling rate temporal difference between the first sampling rate of the first event log data and the second sampling rage of the second event log data,
wherein the first event log data and the second event log data are temporally correlated based on the one or more of the time base temporal difference or the sampling rate temporal difference.

5. The method of claim 4, wherein the one or more of the time base temporal difference or the sampling rate temporal difference is automatically determined by identifying at least a first feature of interest in the first event log data and at least a second feature of interest in the second event log data and determining a difference between when the at least the first feature of interest occurs in the first event log data and when the at least the second feature of interest occurs in the second event log data.

6. The method of claim 4, wherein the first monitoring system includes a first clock providing the first time base for the first event log data and the second monitoring system includes a second clock providing the second time base for the second event log data with the first clock and the second clock set to different times, and further comprising syncing the times of the first clock and the second clock based on the time base temporal difference.

7. The method of claim 1, further comprising determining that the first time base of the first monitoring system differs from the second time base of the second monitoring system due to one or more of clocks of the first and second monitoring systems being set to different time zones or the clocks of the first and second monitoring systems being set to different times but not the different time zones.

8. The method of claim 1, wherein the first operational events represented by the first event log data differ from the second operational events represented by the second event log data.

9. The method of claim 1, wherein the first operational events represented by the first event log data and the second operational events represented by the second event log data are same operational events.

10. The method of claim 1, further comprising visually presenting the first event log data and the second event log data in the common time base on the display device.

11. A system comprising:
a first monitoring system of a powered system configured to generate first event log data representative of first operational events of the powered system and corresponding first times at which the first operational events are recorded by the first monitoring system as occurring;
a second monitoring system of the powered system configured to generate second event log data representative of second operational events of the powered system and corresponding second times at which the second operational events are recorded by the second monitoring system as occurring,
wherein the first monitoring system is configured to record the first event log data at one or more of a first time base that differs from a second time base at which the second monitoring system records the second event log data or a first sampling rate that differs from a second sampling rate at which the second monitoring system records the second event log data; and
a controller configured to temporally correlate the first event log data with the second event log data by one or more of:
changing one or more of the first time base of the first event log data or the second time base of the second event log data to a common time base; or
changing a visual presentation of one or more of the first event log data or the second event log data on a display device such that the first event log data and the second event log data are visually presented with a common time scale responsive to the first sampling rate of the first event log data differing from the second sampling rate of the second event log data.

12. The system of claim 11, wherein the controller is configured to temporally correlate the first event log data with the second event log data by one or more of:
changing the one or more of the first time base of the first event log data or the second time base of the second event log data to the common time base by phase shifting one or more of the first event log data or the second event log data; or
one or more of expanding or contracting a time scale of one or more of the first event log data or the second event log data in the visual presentation.

13. The system of claim 11, wherein the controller also is configured to automatically determine one or more of a time base temporal difference between the first time base of the first event log data and the second time base of the second event log data, or a sampling rate temporal difference between the first sampling rate of the first event log data and the second sampling rage of the second event log data, and
wherein the controller is configured to temporally correlate the first event log data and the second event log data based on the one or more of the time base temporal difference or the sampling rate temporal difference.

14. The system of claim 13, wherein the controller is configured to automatically determine the one or more of the time base temporal difference or the sampling rate temporal difference by identifying at least a first feature of interest in the first event log data and at least a second feature of interest in the second event log data and determining a difference between when the at least the first feature of interest occurs in the first event log data and when the at least the second feature of interest occurs in the second event log data.

15. The system of claim 13, wherein the first monitoring system includes a first clock configured to provide the first time base for the first event log data and the second monitoring system includes a second clock configured to provide the second time base for the second event log data with the first clock and the second clock set to different times,
wherein the controller is configured to communicate the time base temporal difference to one or more of the first monitoring system or the second monitoring system, and
wherein one or more of the first monitoring system or the second monitoring system are configured to sync the first and second clocks based on the time base temporal difference.

16. A system comprising:
a first monitoring system of a powered system configured to generate first event log data representative of first operational events of the powered system and corresponding first times at which the first operational events are recorded by the first monitoring system as occurring;
a second monitoring system of the powered system configured to generate second event log data representative of second operational events of the powered system and corresponding second times at which the second operational events are recorded by the second monitoring system as occurring,
wherein the first monitoring system is configured to record the first event log data at one or more of a first time base that differs from a second time base at which the second monitoring system records the second event log data or a first sampling rate that differs from a second sampling rate at which the second monitoring system records the second event log data; and
a controller configured to temporally correlate the first event log data with the second event log data by automatically determining one or more of a time base temporal difference between the first time base and the second time base, or a sampling rate temporal difference between the first sampling rate and the second sampling rate by identifying at least a first feature of interest in the first event log data and at least a second feature of interest in the second event log data and determining a difference between when the at least the first feature of interest occurs in the first event log data and when the at least the second feature of interest occurs in the second event log data.

17. The system of claim 16, wherein the controller is configured to temporally correlate the first event log data with the second event log data by one or more of:
changing one or more of the first time base of the first event log data or the second time base of the second event log data to a common time base; or
changing a visual presentation of one or more of the first event log data or the second event log data on a display device such that the first event log data and the second event log data are visually presented with a common time scale responsive to the first sampling rate of the first event log data differing from the second sampling rate of the second event log data.

18. The system of claim 16, wherein the controller is configured to temporally correlate the first event log data with the second event log data by one or more of:
changing the one or more of the first time base of the first event log data or the second time base of the second event log data to the common time base by phase shifting one or more of the first event log data or the second event log data; or
one or more of expanding or contracting a time scale of one or more of the first event log data or the second event log data in the visual presentation.

19. The system of claim 16, wherein the first monitoring system includes a first clock configured to provide the first time base for the first event log data and the second monitoring system includes a second clock configured to provide the second time base for the second event log data with the first clock and the second clock set to different times,
wherein the controller is configured to communicate the time base temporal difference to one or more of the first monitoring system or the second monitoring system, and
wherein one or more of the first monitoring system or the second monitoring system are configured to sync the first and second clocks based on the time base temporal difference.

20. The system of claim 16, wherein the first monitoring system and the second monitoring system are configured to monitor one or more of throttle settings of the powered system, brake settings of the powered system, or speeds of the powered system as the first event log data and the second event log data.
